(19) United States
(12) Patent Application Publication
(10) Pub. No.: US 2025/0096601 A1
(43) Pub. Date: Mar. 20, 2025

(54) MODULAR SOLID-STATE POWER MONITOR AND PROTECTION SYSTEM

(71) Applicant: Rockwell Automation Technologies, Inc., Mayfield Heights, OH (US)

(72) Inventors: Aiman Kerim, Aarau (CH); Juerg Merki, Aarau (CH)

(21) Appl. No.: 18/467,565

(22) Filed: Sep. 14, 2023

(51) Int. Cl. H02J 13/00; H02J 3/00

(52) U.S. Cl. CPC H02J 13/00002; H02J 3/0012; H02J 13/00001

(57) ABSTRACT

A system includes one or more modular monitor systems. Each modular monitor system includes a modular control system that controls one or more switches that couple a power source to a load device. Each modular monitor system also includes one or more sensors that acquire sensor data including electrical characteristics associated with a respective modular monitor system. Additionally, the system includes a central monitor system that receives the sensor data, presents the sensor data via a display device integral to the central monitor system, generates one or more control signals based on the sensor data, and transmits the one or more control signals to the one or more modular monitor systems. The one or more control signals may cause a respective modular control system of the respective modular monitor system to operate one or more respective switches.

### BACKGROUND

This disclosure generally relates to control and monitoring circuitry for power systems. More particularly, embodiments of the present disclosure are directed towards using protection circuitry to protect power systems from electrical faults.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

An industrial automation system may include a variety of automatic components associated with different types of motors, motor-drives, converters, inverters, power supplies, and so on. Operations of the automatic components may include using power monitoring circuitry with automatic semiconductor power switches (e.g., switches based on various transistors such as metal-oxide-silicon transistors (MOSFETs), insulated-gate bipolar transistors (IGBTs), or bipolar junction transistors (BJTs), and other semiconductor devices). For example, an automatic semiconductor power switch may automatically switch electrical power between two input power sources. Alternatively, circuit breaker circuitry may include a lock-out switch to prevent specific loads (e.g., motors, motor-drives) from operating on a fault or abnormal condition (e.g., overvoltage) that is out of a design limit (e.g., rated operating voltage).

Additionally, automatic semiconductor power switches may include power supply circuitry, a plurality of sensors, and the like for power monitoring purposes. However, an automation system may include numerous semiconductor power switches, and incorporating such features in each semiconductor power switch may be cost prohibitive. As such, fault-tolerant and cost-efficient power monitoring techniques are desired.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a system may include one or more modular monitor systems. Each modular monitor system may include a modular control system that may control one or more switches that may couple a power source to a load device. Each modular monitor system may also include one or more sensors that may acquire sensor data that may include electrical characteristics associated with a respective modular monitor system Additionally, the system may include a central monitor system that may receive the sensor data, present the sensor data via a display device integral to the central monitor system, generate one or more control signals based on the sensor data, and transmit the one or more control signals to the one or more modular monitor systems. The one or more control signals may cause a respective modular control system of the respective modular monitor system to operate one or more respective switches.

In another embodiment, a method may include receiving, via one or more processors, sensor data including one or more electrical characteristics associated with a respective modular monitor system of multiple modular monitor systems. The method may then include presenting, via the one or more processors, the sensor data via a display device. The method may then include generating, via the one or more processors, one or more control signals based on the sensor data. The method may then include transmitting, via the one or more processors, the one or more control signals to the multiple modular monitor systems. The one or more control signals may cause a modular control system of the respective modular monitor system to operate one or more switches that may couple a power source to a load device.

In yet another embodiment, a system may include a processing system, and the processing system may receive sensor data from one or more modular monitor system. Each modular monitor system may include a modular control system that may control one or more switches that may couple a power source to a load device and one or more sensors that may acquire sensor data including one or more electrical characteristics associated with a respective modular monitor system. The processing system may also present the sensor data via a display device integral to the system, generate one or more control signals based on the sensor data, and transmit the one or more control signals to the one or more modular monitor systems. The one or more control signals may cause a respective modular control system of the respective modular monitor system to operate one or more respective switches.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 illustrates a block diagram of a motor-drive system associated with an industrial automation system, in accordance with an embodiment presented herein;

FIG. 2 illustrates a block diagram of a modular solid-state power monitor and protection system, in accordance with an embodiment presented herein; and

FIG. 3 illustrates a block diagram of a central power monitor system and modular power monitoring systems of a modular solid-state power monitor system, in accordance with an embodiment presented herein; and

FIG. 4 illustrates a block diagram of a central monitor system communicatively and electrically coupled to modular monitor systems, in accordance with an embodiment presented herein; and

FIG. 5 illustrates example user interfaces of modular monitor systems of a modular solid-state power monitor and protection system, in accordance with an embodiment presented herein; and

FIG. 6 illustrates an example user interface of a central monitor system of a modular solid-state power monitor and protection system, in accordance with an embodiment presented herein; and

FIG. 7 illustrates a data flow diagram of communications between a central monitor system and a modular monitor system, in accordance with an embodiment presented herein; and

FIG. 8 illustrates a flow chart of a method for controlling and monitoring power systems, in accordance with an embodiment presented herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. As used herein, the terms “modular” and “modular monitor system” may refer to a usually packaged functional assembly of electronic components, and may include standardized units or dimensions for flexibility and variety in use. Additionally, it should be understood that references to “one embodiment” or “an embodiment” of the present disclosure are not intended to be interpreted as excluding the existence of additional embodiments that also incorporate the recited features.

In certain embodiments, industrial automation systems and automated equipment may include a variety of electrical components, such as motors (e.g., alternating current (AC) motors, direct current (DC) motors), motor-drives (e.g., single phase motors, multiphase motors), converters (e.g., step-up, or step-down power converters), inverters (e.g., AC-to-DC, or DC-to-AC inverters). Additionally, a variety of automatic semiconductor power switches may be used to control operations of the electrical components associated with the automated equipment. For example, one automatic semiconductor power switch may automatically switch electrical power between two 120 volts input power sources (e.g., having different phases) used by an electrical component (e.g., power converter). Alternatively, another automatic semiconductor power switch may serve as lock-out switch to prevent the electrical component from operating on a fault condition (e.g., transient, or sustained overvoltage) that may be over a design limit (e.g., rating voltage of the power converter).

With increasing power ratings of the automated equipment, semiconductor power switches may be vulnerable to certain fault conditions, such as transient (e.g., short and fast) overvoltage, sustained (e.g., enduring and slow) overvoltage, and the like. In such cases, the semiconductor power switches may incorporate some protection features (e.g., overvoltage protections, short circuit protections, surge protections) to be capable of withstanding and protecting itself from the fault conditions. Additionally, semiconductor power switches may include power supply circuitry, sensors, and the like to monitor and control power distribution of an automation system. However, an automation system may include numerous semiconductor power switches, and incorporating such features in each semiconductor power switch of the automation system may be cost prohibitive. Further, relying on a semiconductor power switch may have broad impacts on the automation system if the semiconductor power switch is unable to perform as expected.

Accordingly, as will be described in more detail below, the present disclosure provides techniques to improve efficiency and fault-tolerance of power monitoring and control of an automation system. In some embodiments, a solid-state power monitoring system may include a central monitor system and one or more modular monitor systems. As mentioned above, each modular monitor system may be a usually packaged functional assembly of electronic components, and may include standardized units or dimensions for flexibility and variety in use. Each modular monitor system may include, for example, modular control system circuitry, semiconductor switches, and modular protection circuitry to monitor an electrical load of an automation system, as well as sensors and status indicators to interface with a central monitor system. The central monitor system may include, for example, communication circuitry, processing circuitry, memory, storage, input and output ports, displays, central protection circuitry, a disconnect input (e.g., emergency stop), and central sensors. Additionally, the central monitor system may receive sensor data (e.g., power system measurements) and status information from modular monitor systems, determine desired operations associated with controlling the semiconductor switches of the modular monitor systems, and send the desired operations to respective modular control systems of the modular monitor systems to control the operations of the respective semiconductor switches. In some embodiments, the modular control system may coordinate with a gate driver to generate gate drive signals for controlling the operations of the semiconductor switches. Thus, the one or more modular monitor systems may be controlled at least in part by the central monitor system.

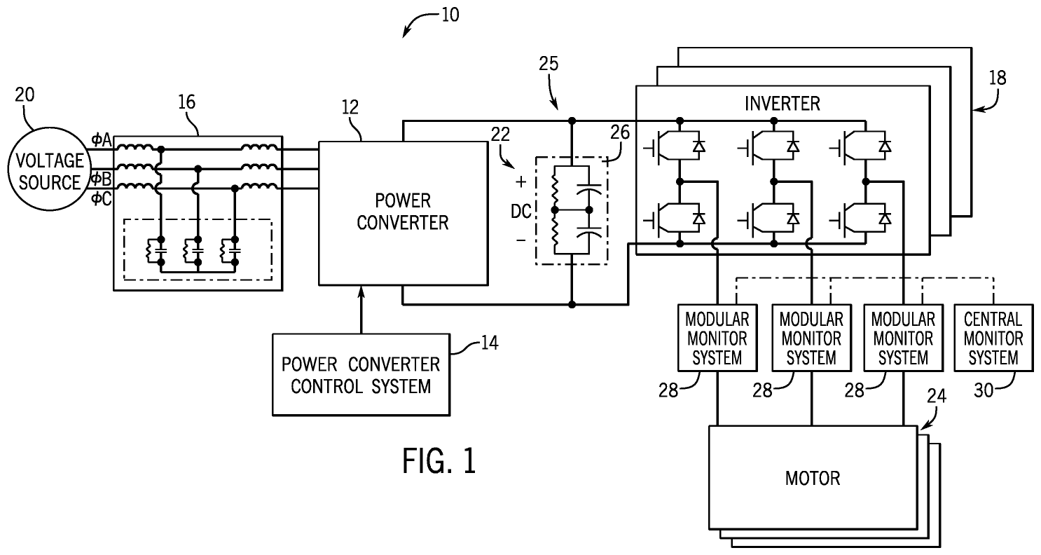

As will be described in more detail below, the central monitor system may provide certain capabilities for the modular monitor systems, thereby reducing the amount of equipment (e.g., processor) and costs for the modular monitor system. For example, the central sensors of the central monitor system may provide sensing capabilities for one or more modular monitor systems, and the central protection circuitry of the central monitor system may provide protection capabilities for one or more modular monitor systems. As such, the power monitoring system may enhance the ability of the modular monitor systems by providing additional capabilities (e.g. backup capabilities). Further, the communication circuitry, processing circuitry, memory, storage, input and output ports, and displays of the central monitor system may provide centralized monitoring and control of the one or more modular monitor systems. Additional details with regard to the embodiments described above will be detailed below with reference to FIGS. 1-8.

By way of introduction, FIG. 1 is a block diagram of a motor-drive system 10, which may be part of an industrial automation system in which the embodiments described herein may be implemented. The motor-drive system 10 may include a power converter 12 and a power converter control system 14 that may control the operation of the power converter 12. The motor-drive system 10 may also include a filter 16 and one or more inverters 18. The filter 16 may filter the input alternating current (AC) voltage provided to the power converter 12, while the one or more inverters 18 may convert the DC voltage output by the power converter 12 into a controllable AC voltage, as will be discussed below. In one embodiment, the filter 16 may be positioned between a voltage source 20 and the power converter 12 to reduce input harmonics that may have been caused by power conversion devices (e.g., thyristors, insulated gate bipolar transistor (IGBT), diodes) switching in power converter 12. It should be noted that, while the embodiments herein are described as being implemented in a motor-drive system 10, other implementations are envisioned. For example, embodiments herein may be implemented as part of, or in conjunction with, power distribution systems, AC power systems, DC power systems, or any other suitable power-consuming device or system.

In general, the power converter 12 may receive three-phase alternating current (AC) voltage from the voltage source 20 and convert the AC voltage into a direct current (DC) voltage 22 suitable for powering loads (e.g., one or more inverters 18). In certain embodiments, the one or more inverters 18 then convert the DC voltage 22 to an AC voltage to be supplied to one or more devices connected to the one or more inverters 18, such as one or more motors 24. The one or more inverters 18 may then, in turn, control the speed, torque, or other suitable operations of the one or more motors 24 by controlling the AC voltage provided to the motors 24. Additionally, power conditions of the motor-drive system 10 (e.g., the AC voltage provided to the motors 24) may be monitored by modular monitor systems 28, and the modular monitor systems 28 may interface with a central monitor system 30 to determine gating signals associated with control of semiconductor switches of the modular monitor systems 28. It should be understood that the industrial automation system may include one or more motor-drive systems 10, and each of the motor-drive systems 10 may include one or more additional components not depicted in FIG. 1.

The power converter 12 and/or one or more inverters 18 may include any suitable rectifier devices that include a number of semiconductor power switches. For example, the power converter 12 may be an active front end (AFE) converter, a diode converter, a thyristor converter, a diode front end rectifier, or the like. In certain embodiments, the semiconductor power switches of the power converter 12, the central monitor system 30, and the modular monitor system 28 may include semiconductor devices, such as transistor-based (e.g., BJT, MOSFET, IGBT, or other suitable transistor-based) devices or other suitable devices in which the opening and/or closing of the semiconductor power switches may be controlled using an external signal (e.g., gating signal), which may be provided by the power converter control system 14. The power converter 12 may provide the DC voltage 22 (e.g., a regulated DC output voltage) on a direct current (DC) bus 25, which may be provided to the one or more inverters 18 and may regenerate extra or additional power back to the voltage source 20. In this way, the power converter 12 may operate to maintain a unity power factor, generate a stable DC voltage (e.g., DC voltage 22) from the voltage source 20, control a power factor transmitted to the one or more inverters 18, or the like to generally control power supplied to the one or more inverters 18.

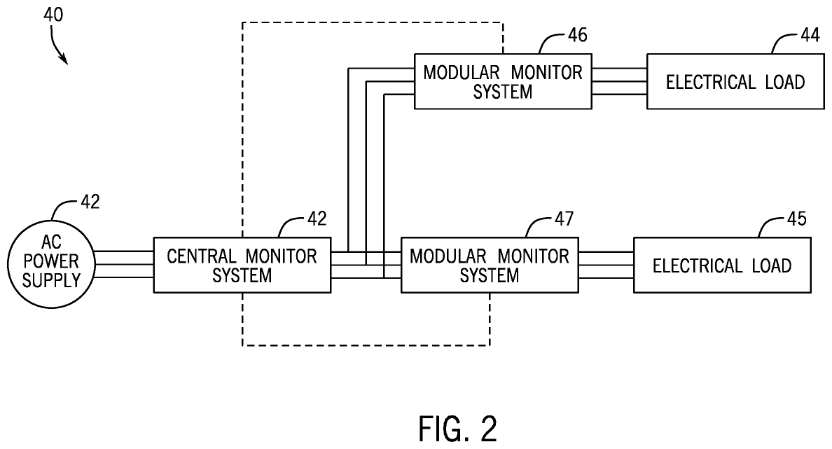

FIG. 2 illustrates a block diagram of a power monitoring system 40 used to monitor a three-phase AC power generated by an AC power supply 42 to supply electrical loads 44 and 45. In particular, a central power monitor system 42 and modular monitor systems 46 and 47 may each be positioned between the AC power supply 42 and the one or more electrical loads 44 and 45. In some embodiments, the modular monitor systems 46 and 47 may monitor electrical characteristics and/or thermal characteristics of the AC current provided to the electrical loads 44 and 45. In the illustrated embodiment, the central monitor system 42 may receive data regarding electrical characteristics and/or thermal characteristics associated with each of the electrical loads 44 and 48 via the modular monitor systems 46 and 47. For example, the modular monitor system 46 may acquire sensor data associated with electrical characteristics of the electrical load 44, while the modular monitor system 47 may acquire sensor data associated with electrical characteristics of the electrical load 45.

It should be understood that while the modular monitor systems 46 and 47 are illustrated as two modular monitor systems, the power monitoring system 40 may include any suitable number of modular monitoring systems. It should also be understood that while each of the modular monitor systems 46 and 47 is illustrated as one modular monitor system respectively, each of the modular monitor systems 46 and 47 may include multiple modular monitor systems. For example, the modular monitor system 47 may include three sub-modular monitor systems, and each of the three sub-modular monitor systems may monitor a respective AC phase (e.g., power line, phase line) of a three-phase AC power used to supply the electrical load 45. Further, while a three-phase AC power generated by the AC power supply 42 is illustrated, in other embodiments, the AC power supply 42 may generate an AC current with a different number of phases (e.g., 1 phase, 6 phases, 9 phases) to supply the electrical loads 44 and 45 or more. Indeed, each phase of the three-phase AC power may be carried by a phase conductor, and the modular solid-state power monitor and protection system 40 may include a modular monitor system for each phase conductor.

In any case, each of the modular monitor systems 46 and 47 may be communicatively connected to the central monitor system 42 via one or more communication links (e.g., wireless, wired, Ethernet). The modular monitor systems 46 and 47 may send, for example, status data, power system measurement signals, and sensor data to the central monitor system 42. The central monitor system 42 may send additional sensor data, gating signals, and/or other suitable data to the modular monitor systems 46 and 47. The central monitor system 42 and the modular monitor systems 46 and 47 may use received signals and/or data (e.g., sensor data) to facilitate the control of semiconductor switches, which may control the flow AC power (e.g., current) to the electrical loads 44 and 45. For example, the modular monitor system 46 may disconnect one or more phase currents of the three-phase AC power from the electrical load 44 via one or more respective semiconductor switches based on signals received from the central monitor system 42 to avoid an overcurrent condition.

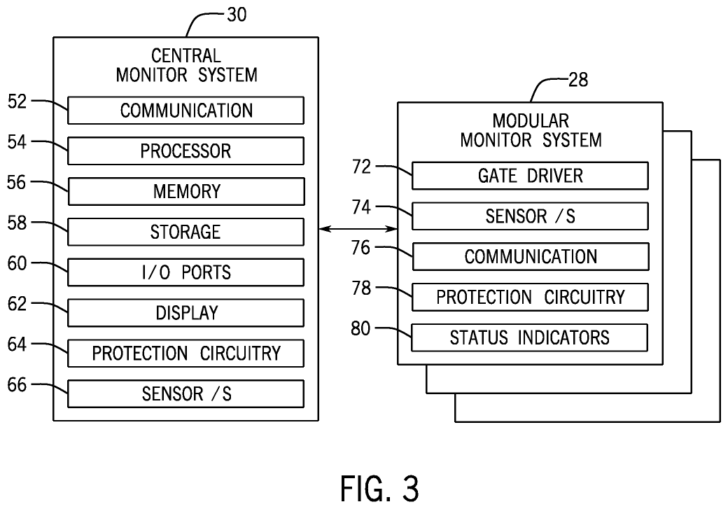

With the foregoing in mind, FIG. 3 illustrates example components of the central monitor system 30 (e.g., central monitor system 42) and the modular monitor systems 28 (e.g., modular monitor system 46 and 47) as described herein. For example, the central monitor system 30 may include a central communication component 52, a processor 54, a memory 56, a storage 58, input/output (I/O) ports 60, a display 62, central protection circuitry 64, central sensors 66, and the like. Each modular monitor system of the one or more modular monitor systems 28 may include, for example, a modular control system 72, modular sensors 74, a modular communication component 76, modular protection circuitry 78, status indicators 80, and the like. The central communication component 52 may be a wireless or wired communication component that may facilitate communication between, for example, the one or more modular monitor systems 28 (e.g., via the modular communication component 76), a computing device, a cloud-based computing system, and other communication capable devices.

The processor 54 may be any type of computer processor or microprocessor capable of executing computer-executable code. The processor 54 may also include multiple processors that may perform the operations described below. The memory 56 and the storage 58 may be any suitable articles of manufacture that can serve as media to store processor-executable code, data, or the like. These articles of manufacture may represent computer-readable media (e.g., any suitable form of memory or storage) that may store the processor-executable code used by the processor 54 to perform the presently disclosed techniques. Generally, the processor 54 may execute software applications that include programs that may monitor an electrical system, receive signals from the one or more modular monitor systems 28, generate gating signals based on the received signals, and so on. That is, the software applications may communicate with the central monitor system 30 and gather information associated with the modular monitor system 28 as determined by the central monitor system 30, via the modular sensors 74 disposed on the one or more modular monitor systems 28 and the like.

The memory 56 and the storage 58 may also be used to store the data, analysis of the data, the software applications, and so on. The memory 56 and the storage 58 may represent non-transitory computer-readable media (e.g., any suitable form of memory or storage) that may store the processor-executable code used by the processor 54 to perform various techniques described herein. It should be noted that non-transitory merely indicates that the media is tangible and not a signal.

In one embodiment, the memory 56 and/or storage 58 may include a software application that may be executed by the processor 54 and may be used to monitor, control, access, or view one of the modular monitor systems 28. The software application may perform various functionalities, such as track input from a user of the central monitor system 30, track power system measurements from the one or more modular monitor systems 28, determine statuses of the one or more modular monitor systems, display status indications of the one or more modular monitor systems 28, determine gating signals to send to the one or more modular monitor systems 28, and so forth. In some embodiments, the central monitor system 30 may retrieve data from the modular sensors 74. The modular sensors 74 may include any suitable sensors such as current sensors, voltage sensors, temperature sensors, and the like. In some embodiments, the modular sensors 74 may collect sensor data and store the datasets in a storage component or memory, which may be accessible by the central monitor system 30 or other suitable device at a later time.

The I/O ports 60 may be interfaces that may couple to other peripheral components such as input devices (e.g., keyboard, mouse, lever, button), sensors, input/output (I/O) modules, and the like. I/O modules may enable, for example, a computing device or other central monitor systems 30 to communicate with the modular monitor systems 56 or other devices in the industrial automation system via the I/O modules.

The display 62 may depict visualizations associated with software or executable code being processed by the processor 54, and may be integral to the central monitor system 30. That is, the display 62 may be connected as part of the central monitor system 30. In one embodiment, the display 62 may be a touch display capable of receiving inputs (e.g., inputs to control the modular monitor systems 28) from a user of the central monitor system. As such, the display 86 may serve as a user interface to communicate with the modular monitor systems 28. The display 62 may be used to display a graphical user interface (GUI) for operating the modular monitor systems 28, for tracking the sensor data of modular monitor systems 28, and the like. The display 86 may be any suitable type of display, such as a liquid crystal display (LCD), plasma display, or an organic light emitting diode (OLED) display, for example. Additionally, in one embodiment, the display 62 may be provided in conjunction with a touch-sensitive mechanism (e.g., a touch screen) that may function as part of a control interface for the modular solid-state power monitor and protection system or for a number of pieces of industrial automation equipment in the motor-drive system 10 to control the general operations of the motor-drive system 10.

The central protection circuitry 64 may provide circuit protection capabilities for components of the central monitor system 30. In the same way, the modular protection circuitry 78 may provide circuit protection for the modular monitor systems 28. As such, the central protection circuitry 64 may provide supplementary protection capabilities for the modular protection circuitry 78 of each of the one or more modular monitor systems 28. For example, the central protection circuitry 64 may provide backup (e.g., reserve) protection capabilities for the modular protection circuitry 78 when a fault is detected in the modular protection circuitry 78. By way of example, the central protection circuitry 64 and the modular protection circuitry 78 may include diodes, relays, fuses, MOVs, transient protection circuitry (e.g., Zener-type diodes), current-limiting devices (e.g., fuses, circuit breakers, thermal trip devices), electromechanical disconnectors, or other suitable protection circuitry components that may perform protection measures (e.g., trip a protection circuit) for detected conditions (e.g., overvoltage, overcurrent). In some embodiments, a user of the central monitor system 30 may remotely instruct the modular protection circuitry 78 to perform a protection measure via, for example, the I/O ports 60. In this case, the central protection circuitry 64 and/or the modular protection circuitry 78 may include power switches (e.g., semiconductor power switches, IGBTs, thyristors, air gaps, etc.) that may be controlled remotely based on signals transmitted to the respective switches. In some embodiments, the central protection circuitry 64 may have more and/or different protection capabilities and components than the modular protection circuitry 78 to provide a breadth of circuit protection features.

The central sensors 66 may generate data associated with electrical characteristics of the motor-drive system 10 and/or the power monitoring system. For example, the central sensors 66 may measure a current, voltage, and/or power of each phase of a three-phase AC power supply. As with the central protection circuitry 64, the central sensors 66 may provide additional data context with respect to the data acquired by the modular sensors 74 of the modular monitor system 28. In some embodiments, the central sensors 66 may measure more and/or different electrical characteristics or thermal characteristics than the modular sensors 74. For example, the central sensors 66 may measure a current, voltage, and power of each phase the three-phase AC power supply, while the modular sensors 74 may measure a current and temperature of a particular phase of the three-phase AC power supply. In any case, the data generated by the central sensors 66 and modular sensors 74 may be communicated between the central monitor system 30 and the modular monitor system 28 (e.g., via the communication component 52 and the communication component 76) and/or used by the central protection circuitry 64 and/or the modular protection circuitry 78.

The status indicators 80 may indicate statuses based on, for example, the data generated by the modular sensors 74 or a state (e.g., open/closed) of the modular protection circuitry 78. The status indicators 80 may include a liquid crystal display (LCD), plasma display, or an organic light emitting diode (OLED) display, for example, and may display the indications for view by a user. The statuses may include, for example, either nominal or fault conditions, which may be represented by a green indication or a red indication (e.g., fault), respectively. The indications may also indicate an open or closed condition representing the state of the modular protection circuitry 78, indications of current values, temperature values, and voltage values (e.g., as generated by the modular sensors 74), and so on.

The modular control system 72 may receive control signals (e.g., from the central monitor system 30 via the communication component 76, from the sensors 74) and instruct the modular protection circuitry 78 based on the control signals. For example, a received control signal may correspond to instructions to interrupt an AC power supply to an electrical load, and the modular control system may send a gating signal (e.g., remove gate signal) to a semiconductor device (e.g., gate of semiconductor device) to cause the semiconductor device to open and interrupt the AC current (e.g., or DC current). The modular control system 72 may include a circuit board, controller, processing device, or one or more other suitable components capable of implementing gate-driving techniques of the respective semiconductor switch.

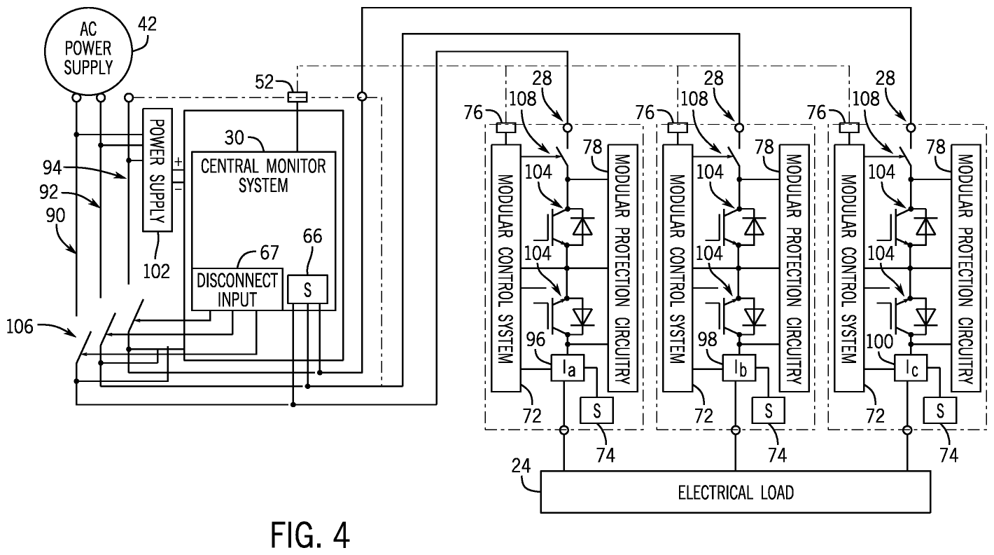

FIG. 4 illustrates a block diagram of the central monitor system 30 and three modular monitor systems 28. As shown in FIG. 4, the three-phase AC power may be supplied at least in part by, for example, the AC power supply 42 mentioned above. In some embodiments a power supply 102 may step down the voltage from the AC power supply 42 to provide a suitable voltage to the central monitor system 30, the modular monitor system 28, and other suitable devices to operate. In the illustrated embodiment, the central monitor system 30 and the modular monitor systems 28 monitor a three-phase AC power carried by a first phase 90, a second phase 92, and a third phase 94. In particular, the central monitor system 30 may monitor each of the first phase 90, the second phase 92, and the third phase 94, and each of the one or more modular monitor systems 28 may monitor a respective phase of the three phases 90, 92, and 94. For example, a first modular monitor system of the modular monitor systems 28 may monitor the first phase 90, a second modular monitor system of the modular monitor systems 28 may monitor the second phase 92, and a third modular monitor system of the modular monitor systems 28 may monitor the third phase 94.

As described herein, the central monitor system 30 may include central sensors 66 that monitor electrical characteristics of the three phase 90, 92, and 94. In the illustrated embodiment, each of the modular monitor systems 28 may include modular sensors 74 that may monitor, for example, a first current value 96 of the first phase 90, a second current value 98 of the second phase 92, and a third current value 100 of the third phase 94. As illustrated, the modular sensors 74 may be positioned in series with semiconductor power switches 104 of the modular monitor systems 28. By way of example, phase current values 96, 98, and 100 may be detected by the sensors 74 and sent to the central monitor system 30 via the modular communication components 76 and the central communication component 52. It should be noted that the modular sensors 74 may monitor other electrical characteristics such as voltage values, power values, thermal values and so on. The modular sensors 74 may monitor, for example, a first thermal value (e.g., temperature) of the first phase 90, a second thermal value of the second phase 92, and a third thermal value of the third phase 94.

The central monitor system 30 may generate gating signals based on the data acquired by the central sensors 66, data provided by the modular sensors 74, the three current values 96, 98, and 100, and the like. That is, if the central monitor system 30 determines that the received data exceeds some threshold or is outside some threshold range of values, the central monitor system 30 may generate gating instructions that may be sent to the gate drives 72 of the modular monitor systems 28. The central monitor system 30 may, for example, generate different gating signals for each of the modular control systems 78 based on, for example, differences in the current values 96, 98, and 100. Additionally or alternatively, the central monitor system 30 may determine gating signals for a modular monitor system 28 based on a current value at a different modular monitor system 28. For example, if the current value 96 indicates a short circuit condition, the central monitor system 30 may generate gating signals instructing each of the gate drives 72 to cause one or more of the semiconductor devices 104 to open a circuit. That is, the central monitor system 30 may control the flow of current via phases 90, 92, and 94 to the electrical load 24 in response to detecting a fault condition within the system.

In some embodiments, the central monitor system 30 may determine an anomalous and/or fault condition (e.g., the short circuit condition, an overvoltage condition) based on a comparison between the received current values 96, 98, and 100 and a threshold range. If the received values include other characteristics, such as temperatures, voltages, and the like, the central monitor system 30 may compare the other characteristics with corresponding threshold ranges. For example, if the received values include temperature values, the central monitor system 30 may compare the received temperature values to a threshold temperature range to determine an anomalous condition, such as thermal breakdown of the junction regions of the semiconductor switches 104. Additionally, the received values may include electrical characteristics and/or thermal characteristics, and the central monitor system 30 may determine (e.g., predict, model) a temperature of, for example, a junction of the semiconductor switches 104. In any case, if the received values are outside of the threshold range, the central monitor system 30 may send gating signals indicative of instructions to open the semiconductor switches 104 of the one or more modular monitor systems 28, which may prevent current from supplying the electrical load 24.

Further, the central monitor system 30 may control semiconductor switches (not shown) of the central protection circuitry 64 based on the data acquired by the central sensors 66, the modular sensors 74, the three current values 96, 98, and 100, thermal values, and the like. As described herein, the central protection circuitry 64 may be positioned on each of the three phase 90, 92, and 94, and may include power switches, transient protection circuitry and/or current-limiting devices. The central protection circuitry 64 may operate supplementary to, or in conjunction with the semiconductor switches 104 of the modular monitor systems 28 to interrupt current flow. That is, the central protection circuitry 64 may open (e.g., block) a portion or all of the three phase 90, 92, and 94 from delivering the three-phase AC power to the modular monitor systems 28. The central monitor system 30 may also instruct the central protection circuitry 64 in response to receiving user input (e.g., via the I/O ports 60) corresponding to certain commands.

In addition to controlling the semiconductor switches 104 of the modular monitor systems 28 and the central monitor system 30, the central monitor system 30 may also control operations of an air gap disconnect switch 106 (e.g., via solenoid). In the same manner, the gate drive 76 may control operations of an air gap disconnect switch 108 (e.g., via solenoid) based on instructions from the central monitor system 30. It should be noted that the air gap disconnect switches 106 and 108 may be controlled remotely (e.g., via communication network) or via manual operation by a user. For example, a user may manually engage a disconnect input (e.g., emergency stop input) 67 to cause the air gap disconnect switch 106 to open. As another example, a user may move a lever to a trip position, for example, to cause the air gap disconnect switches 106 and 108 to open.

As described herein, each of the modular monitor systems 28 may include a modular control system 72. Each modular control system 72 may instruct the semiconductor switches 104 and the air gap disconnect switches 108 to open or close based on the signals received from the central monitor system 30 via, for example, the central communication component 52 and the modular communication component 76. In some embodiments, the modular control system 72 include or communicate with a gate driver, such that the modular control system 72 and/or the gate driver may send gating signals to the semiconductor switches 104. The modular control system 72 may send gating signals that instruct semiconductor switches 104, for example, to open, thereby disconnecting the first, second, or third phase 90, 92, 94 from the electrical load 24.

In some embodiments, each modular control system 72 may instruct associated modular protection circuitry 78 based on the data from the first, second, or third sensor (e.g., the first, second or third current value 96, 98, or 100). For example, if data from a sensor 74 of a modular monitor system indicates a fault condition, the modular control system 72 of the respective modular monitor system 28 may instruct the associated semiconductor switch 104 to open a circuit, thereby interrupting a phase current from being delivered to the electrical load 24. That is, the modular control system 72 may instruct the modular protection circuitry 78 without receiving command signals from the central monitor system 30.

In some embodiments, the modular control system 72 may generate gate signals for the semiconductor switches 104 based on data received from the modular sensors 74 (e.g., directly operate based on sensor data). The gate signals may be provided to cause the semiconductor switches 104 to open (e.g., block an AC power supply) when data from the sensors 74 indicates an anomalous or fault condition is present. That is, the modular monitor system 28 may operate independent of communications with the central monitor system 30. This may be advantageous when the electrical load 24 is particularly sensitive to transient conditions, and response from the power monitoring system must be rapid, for example.

In addition, status information of the semiconductor switches 104, the air gap disconnect switch 108, or the like may be communicated from the modular protection circuitry 78 as status information to the central monitor system 30. Status information of the modular protection circuitry 78 may include control instructions (e.g., open or closed) of the modular protection circuitry 78, data acquired by the sensors 74, such as the currents 96, 98, and 100, and so on. These statuses may be displayed to a user via the status indicators 80 of the modular monitor system 28, via the display 62 of the central monitor system 30, and the like. Additionally, status information may be used by the central monitor system 30 to instruct devices of the central protection circuitry 64 or generate gating signals for the one or more modular monitor systems 28.

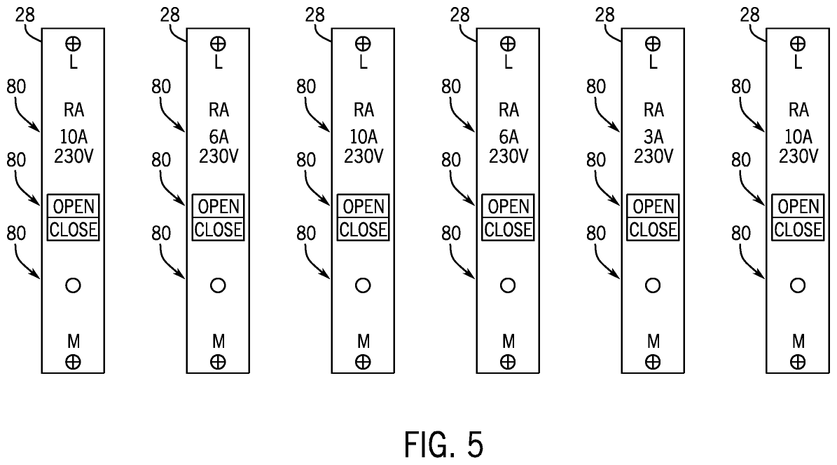

FIG. 5 illustrates example user interfaces of six modular monitor systems 28 discussed with reference to FIGS. 3 and 4, including status indicators 80 that may display status information to a user. In the illustrated embodiment, the status indicators 80 include, for example, indications of currents (e.g., the currents 96, 98, and 100), voltages (e.g., as measured by the sensors 74), status information (e.g., state, open/close) of the semiconductor switches 104, and so on. As illustrated, the status indicators 80 may also include color-based (e.g., green, red) and/or textual (e.g., “open”, “close”) indications corresponding to control instructions of the modular protection circuitry 78, for example. Additionally or alternatively, the status indicators 80 may include a button or other suitable device that allows user input, and the user input may be transmitted to the central monitor system 30 and/or used to generate gating signals for the one or more modular monitor systems 28. For example, user input to a status indicator 80 with an “open” textual indication may cause a modular monitor system 28 to instruct the semiconductor switches 104 and the air gap disconnect switches 108 to open.

Additionally or alternatively, the status indicators 80 may include displays, such as liquid crystal displays (LCDs), plasma displays, or an organic light emitting diodes (OLEDs). The displays may present, for example, the indications of currents, the indications of voltages, open or closed indications, and/or other suitable status information to a user. The displays may also include touch displays capable of receiving inputs (e.g., inputs to control the modular monitor systems 28) from a user. As such, the displays may serve as a user interface to communicate with the modular monitor systems 28.

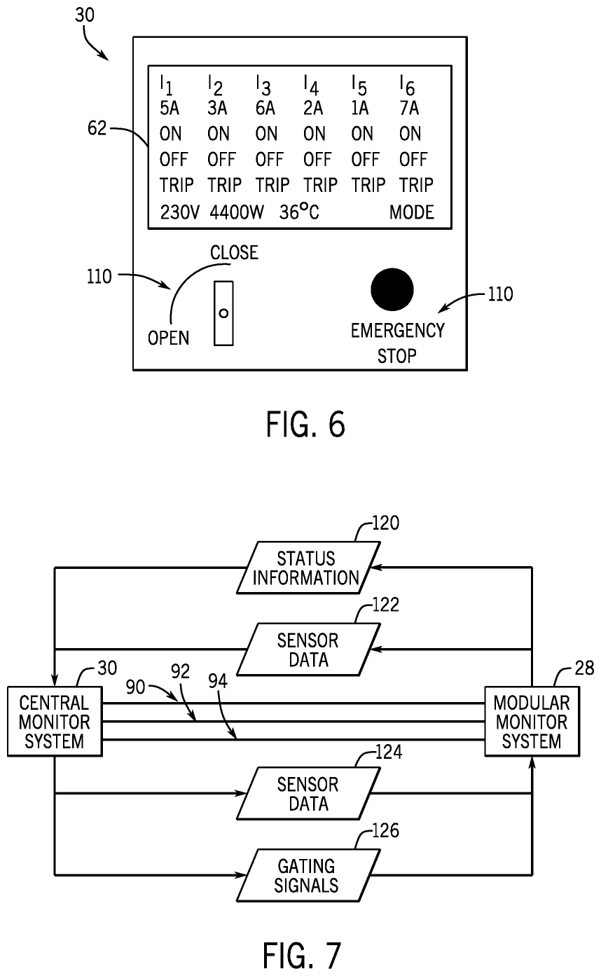

FIG. 6 illustrates an example user interface of the central monitor system 30 of FIGS. 3 and 4, including the display 62 and user input devices 110. In the illustrated embodiment, the display 62 may include liquid crystal displays (LCDs), plasma displays, or an organic light emitting diodes (OLEDs) and the like, and may present indications of status information associated with the modular monitor systems 28 an/or the central monitor system 30. The indications may include, for example, sensor data as collected by the modular sensors 74 or the central sensors 66, control instructions of the modular protection circuitry (e.g., on/off), o and the like. It should be noted that while one display 62 is illustrated, the central monitor system may include two or more displays 62 (e.g., a display 62 for each modular monitor system 28) to present the indications as discussed herein.

Additionally, the user input devices 110 may allow a user to instruct components of the central monitor system 30 or the modular monitor systems via, for example, the I/O ports 60. As illustrated, the user input devices 110 may include an open/close lever that may allow a user to select signals to send to the modular monitor systems 28, and an emergency stop button (e.g., the disconnect input 67 of FIG. 4) that may allow a user to control the air gap disconnect switches 106, as examples. Additionally, or alternatively, the user input devices 110 may include touch displays capable of receiving input from a user, and the touch displays may be implemented as part of or in conjunction with the display 62.

FIG. 7 illustrates a data flow diagram of communications between the central monitor system 30 and the modular monitor systems 28 of FIG. 4. In the illustrated embodiment, the central monitor system 30 and the modular monitor systems 28 monitor a AC power (e.g., voltage, current) carried by a first phase 90, a second phase 92, and a third phase 94, as discussed above. Additionally, the modular monitor systems 28 may communicate status information 120 and sensor data 122 to the central monitor system 30. The status information 120 may include status information (e.g., state, open/closed) of the semiconductor switches 104, the air gap disconnect switch 108, or the modular protection circuitry 78, and the sensor data 122 may include data acquired by the sensors 74, such as the currents 96, 98, and 100. The status information 120 and/or sensor data 122 may be displayed to a user via the display 62 of the central monitor system 30 and/or used to instruct devices of the central protection circuitry 64.

The central monitor system 30 may generate gating signals 126 based on, for example, the status information 120, the sensor data 122, and user input, and transmit the gating signals 126 to the modular monitor system 28. For example, the central monitor system 30 determine that the received sensor data 122 exceeds some threshold or is outside some threshold range of values, and generate the gating signals 126 based on the determination. As described above, the modular monitor system may then instruct the semiconductor switches 104 and the air gap disconnect switches 108 to open or close based on the received gating signals 126. In addition, the central monitor system 30 may send sensor data (e.g., sensor data collected by the central sensors 66) to the modular monitor system to be displayed via the status indicators 80 or used to generate control instructions of the modular protection circuitry 78, as examples.

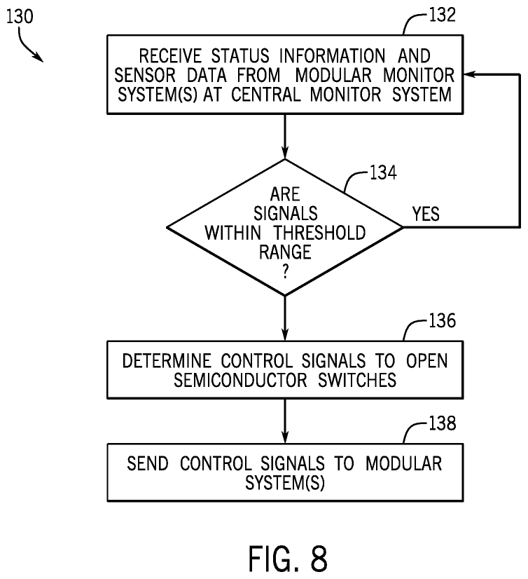

With the above in mind, FIG. 8 illustrates a flow chart of a method 130 for controlling and monitoring power systems using the central monitor system 30 and the modular monitor system 28. Although the method 130 is described as being performed in a particular order, it should be noted that the method 130 may be performed in any suitable order.

Referring to FIG. 8, at block 132, the central monitor system 30 may receive status information and sensor data from the modular monitor systems 28. As mentioned, the status information may include status information of semiconductor switches, air gap disconnect switches, or modular protection circuitry, such as an open or closed control instructions. The sensor data may include data collected by modular sensors of the modular monitor systems 28, such as currents, voltages, temperatures, and the like.

At block 134, the central monitor system 30 may compare the received signals (e.g., the status information and/or the sensor data) to a threshold value or threshold range of values. For example, if the received sensor data includes a temperature value, the central monitor system 30 may compare the temperature value to a threshold temperature value or range of temperature values. If it is determined that the received signals do not exceed the threshold value and/or are within the threshold range, the central monitor system 30 may return to block 132 and continue to receive status information and sensor data.

If the received signals exceed a threshold value or are outside a threshold range, the central monitor system 30 may proceed to block 136. At block 136, the central monitor system 30 may generate control signals indicative of instructions to open semiconductor power switches. The received signals exceeding a threshold value or being outside a threshold range may, for example, correspond to an anomalous and/or fault condition, such as a short circuit condition. After generating the control signals, at block 138, the central monitor system 30 may send the control signals to an appropriate modular monitor system 28. The respective modular monitor system 28 may receive the control signals, which may cause a respective modular control system to generate gate signals to modify operations of the semiconductor switch(es) of the respective modular monitor systems 28. For instance, the gate signals may cause the semiconductor power switches to open, thereby preventing current from being coupled to an electrical load.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

While only certain features of the present embodiments described herein have been illustrated and described herein, many modifications and changes will occur to those skilled in the art. It is, therefore, to be understood that the appended claims are intended to cover all such modifications and changes as fall within the true spirit of the disclosure.

What is claimed is:

1. A system, comprising:
one or more modular monitor systems, wherein each modular monitor system comprises:
a modular control system configured to control one or more switches configured to couple a power source to a load device; and
one or more sensors configured to acquire sensor data comprising one or more electrical characteristics associated with a respective modular monitor system; and
a central monitor system configured to:
receive the sensor data;
present the sensor data via a display device integral to the central monitor system;
generate one or more control signals based on the sensor data; and
transmit the one or more control signals to the one or more modular monitor systems, wherein the one or more control signals are configured to cause a respective modular control system of the respective modular monitor system to operate one or more respective switches.

2. The system of claim 1, wherein the central monitor system comprises one or more additional sensors configured to acquire additional sensor data associated with one or more additional electrical characteristics between the central monitor system and at least one of the one or more modular monitor systems.

3. The system of claim 2, wherein the central monitor system is configured to generate one or more additional control signals based on the sensor data and the additional sensor data, wherein the one or more additional control signals are configured to open one or more additional switches configured to electrically couple the power source from the one or more modular monitor systems.

4. The system of claim 2, wherein the central monitor system is configured to:
generate a first control signal and a second control signal based on the sensor data and the additional sensor data;
transmit the first control signal to a first modular monitor system of the one or more modular monitor systems; and
transmit the second control signal to a second modular monitor system of the one or more modular monitor systems.

5. The system of claim 2, wherein the central monitor system comprises one or more additional switches configured to couple power to the one or more modular monitor systems.

6. The system of claim 5, wherein the central monitor system is is configured to control the one or more additional switches based on the sensor data and the additional sensor data.

7. The system of claim 2, wherein the central monitor system comprises an air gap disconnect switch.

8. The system of claim 1, wherein the one or more modular switches comprises an air gap disconnect switch.

9. The system of claim 1, wherein each of the one or more modular monitor systems comprises protection circuitry configured to protect the one or more respective switches.

10. A method, comprising:
receiving, via one or more processors, sensor data comprising one or more electrical characteristics associated with a respective modular monitor system of a plurality of modular monitor systems;
presenting, via the one or more processors, the sensor data via a display device;
generating, via the one or more processors, one or more control signals based on the sensor data; and
transmitting, via the one or more processors, the one or more control signals to the plurality of modular monitor systems, wherein the one or more control signals are configured to cause a modular control system of the respective module monitor system to operate one or more switches configured to couple a power source to a load device.

11. The method of claim 10, comprising:
receiving, via the one or more processors, status information of the one or more switches and protection circuitry, the protection circuitry configured to protect the one or more switches; and
presenting, via the one or more processors, the status information via the display device.

12. The method of claim 11, wherein the status information indicates an open condition or a closed condition associated with each of the one or more switches.

13. The method of claim 11, comprising generating, via the one or more processors, the one or more control signals based on the sensor data and the status information.

14. The method of claim 11, comprising controlling, via the one or more processors, one or more additional switches based on the sensor data and the status information, the one or more additional switches configured to couple power to the plurality of modular monitor systems.

15. The method of claim 11, comprising:
generating, via the one or more processors, a first control signal and a second control signal based on the sensor data and the status information;
transmitting, via the one or more processors, the first control signal to a first modular monitor system of the plurality of modular monitor systems; and
transmitting, via the one or more processors, the second control signal to a second modular monitor system of the plurality of modular monitor systems.

16. A system, comprising:
a processing system configured to:
receive sensor data from one or more modular monitor systems, wherein each modular monitor system comprises:
a modular control system configured to control one or more switches configured to couple a power source to a load device; and
one or more sensors configured to acquire the sensor data comprising one or more electrical characteristics associated with a respective modular monitor system;
present the sensor data via a display device integral to the system;
generate one or more control signals based on the sensor data; and
transmit the one or more control signals to the one or more modular monitor systems, wherein the one or more control signals are configured to cause a respective modular control system of the respective module monitor system to operate one or more respective switches.

17. The system of claim 16, wherein the processing system is configured to:
receive additional sensor data from one or more additional sensors integral to the processing system, the one or more additional sensors configured to acquire additional sensor data associated with one or more additional electrical characteristics between the processing system and at least one of the one or more modular monitor systems; and
generate the one or more control signals based on the sensor data and the additional sensor data.

18. The system of claim 17, wherein the processing system is configured to:
receive status information of the one or more switches and protection circuitry, the protection circuitry configured to protect the one or more switches from electrical damage; and
generate the one or more control signals based on the sensor data, additional sensor data, and the status information.

19. The system of claim 16, wherein the processing system is configured to:
receive user input from one or more user input devices; and
control one or more air gap disconnect switches configured to couple power to the one or more modular monitor systems based on the user input.

20. The system of claim 16, wherein each modular monitor system is configured to:
receive the sensor data from the one or more sensors; and
modify one or more operations of the one or more switches based on the sensor data.
